(19) United States
(12) Patent Application Publication
(10) Pub. No.: US 2025/0158261 A1
(43) Pub. Date: May 15, 2025

(54) Multi-Layer Filter Arrangement

(71) Applicant: Gapwaves AB, Göteborg (SE)

(72) Inventors: Abbas VOSOOGH, Göteborg (SE); Morteza Rezaee, Sabzevzr (IR)

(21) Appl. No.: 18/947,471

(22) Filed: Nov. 14, 2024

(30) Foreign Application Priority Data
Nov. 15, 2023 (SE) 2351303-9

(51) Int. Cl. H01P 1/213

(52) U.S. Cl. CPC H01P 1/2138

(57) ABSTRACT

The present disclosure relates to an electromagnetic filter arrangement and a diplexer arrangement. The filter arrangement comprises a top layer, a bottom layer and a filter layer arranged between the top and bottom layer. The filter arrangement further comprises an upper layer between the top and filter layer, and a lower layer arranged between the bottom and filter layer and the upper and lower layer comprises an elongated aperture forming a waveguide channel wherein each waveguide channel extending so as to overlap, with the first and second opening. The filter layer comprises filter apertures arranged intermittently along the waveguide channels of the at least one upper layer and the at least one lower layer.

### CROSS-REFERENCE TO RELATED APPLICATION

The present application claims priority to and the benefit of Swedish Patent Application No. 2351303-9 filed Nov. 15, 2023. The entire disclosure of Swedish Patent Application No. 2351303-9 is incorporated herein by reference.

### TECHNICAL FIELD OF THE INVENTION

The present invention relates to a filter arrangement for electromagnetic signals and a multilayer diplexer, and particularly to a multi-layer filter and diplexer with a shallow metasurface and thin layers.

### BACKGROUND OF THE INVENTION

Filters for filtering electromagnetic signals are essential in many implementations, including the field of telecommunication and RADAR applications. An electromagnetic filter is a circuit or waveguiding structure which attenuates electromagnetic signals with a frequency falling in a stop band while electromagnetic signals with a frequency falling in the pass band are able to pass the filter. For example, when transmitting electromagnetic signals with an antenna it is important to ensure that the electromagnetic signals are confined to a predetermined frequency band (which e.g. is set by band allocation regulations in each country or region) so as to not disturb other wireless communication in adjacent frequency bands.

An electromagnetic filter can be realized simply with a circuit using active components, passive components, or both. For example, a simple high-pass or low-pass filter can be realized with capacitors and inductors.

Additionally, it is also possible to realize an electromagnetic filter with a waveguide. For example, a rectangular waveguide can be provided with various inserts such as thin metal plates provided with an iris, dielectric resonators and/or conductive posts that extend inside the rectangular waveguide. Depending on the dimensions and placement of the inserts it is possible to form a waveguide that is frequency selective and acts as a filter, allowing some electromagnetic signals of some frequencies, but not other frequencies, to pass.

A drawback with existing waveguide filters is that they are difficult to manufacture with sufficient precision to avoid leakage and degraded efficiency. Especially, when higher frequencies are used, the dimensions of the waveguide (and any inserts used to form a filter) shrinks and the requirement on manufacturing tolerances increases. Accordingly, as higher frequencies are becoming more and more important in many applications it has rapidly become challenging to manufacture waveguide filters with sufficient accuracy.

### GENERAL DISCLOSURE OF THE INVENTION

It is an object of the present invention to overcome at least some of the shortcomings of the prior solutions and provide a multi-layer filter that offers improved performance, even at high frequencies, while being simple to manufacture and compact.

According to a first aspect of the invention there is provided an electromagnetic filter arrangement comprising a plurality of stacked layers. The stacked layers comprising a top layer, a bottom layer, a filter layer arranged between the top layer and bottom layer, at least one upper layer arranged between the top layer and the filter layer, and at least one lower layer arranged between the bottom layer and the filter layer. Wherein the top layer comprises a first opening and the bottom layer comprises a second opening, the second opening being displaced from the first opening in a longitudinal plane, the longitudinal plane being parallel to the stacked layers. Wherein at least one of the at least one upper layer and at least one of the at least one lower layer comprises an elongated aperture forming a waveguide channel, each waveguide channel extending so as to overlap, when seen in a direction normal to the longitudinal plane, with the first and second opening, respectively. Wherein the filter layer comprises a first set of filter apertures, the filter apertures of the first set being arranged intermittently along the waveguide channels of the at least one upper layer and the at least one lower layer. Wherein a metasurface is arranged between the at least one upper layer and the filter layer and between the at least one lower layer and the filter layer, respectively, wherein the metasurface surrounds the waveguide channel and wherein the metasurface comprises a plurality of thick and thin sections.

With this stacked layer design a filter arrangement with excellent filter properties is provided which is compact and suitable for high frequencies, such as frequencies above 10 GHZ, frequencies above 30 GHz or frequencies above 50 GHz. The filter arrangement can also be manufactured in a cost efficient manner, e.g. the layers can be manufactured individually and assembled to form the filter arrangement. Due to the properties of the metasurface the assembly tolerances of the layers are increased for maintained filter performance. For example, it is not essential to arrange the layers at a specific separation distance since the metasurface will confine the electromagnetic waves if the layers are spaced apart as well as if the layers are in contact with each other.

In use, an electromagnetic signal is injected into one of the first and second opening and travels along the waveguide channel of the upper and lower layer while interacting with the filter apertures in the filter layer. This results in a filtering of the signal whereby a filtered electromagnetic signal exits through the other one of the first and second opening.

In some implementations, the electromagnetic filter arrangement further comprises a double aperture upper layer. Wherein the double aperture upper layer is arranged between the top layer and the at least one upper layer, wherein the double aperture upper layer comprises two separate apertures arranged along the waveguide channel, a first aperture overlapping with the first opening and a second aperture extending along the waveguide channel when seen in a direction normal to the longitudinal plane, wherein the separate apertures of the double aperture upper layer are surrounded by a common metasurface.

The double aperture upper layer contributes to forcing the propagation of the electromagnetic signals to interact with the filter apertures by preventing the electromagnetic signals from propagating from one opening to the other inside the waveguide channel without interacting as much with the filter apertures. The second aperture of the double aperture upper layer overlaps at least with the filter apertures but does not overlap with the second opening in the bottom layer, when seen in a direction normal to the longitudinal plane.

Optionally, the metasurface surrounding the apertures of the double aperture upper layer is arranged on a bottom surface of the double aperture upper layer facing the at least one upper layer, wherein the metasurface of the double aperture upper layer surrounds a common area, and wherein said two separate apertures of the double aperture upper layer are arranged inside the common area.

The common metasurface therefore forms a waveguiding channel which allows the electromagnetic signals to propagate along the intermittently arranged filter apertures. A space of the common area between the two separate apertures in the double aperture upper layer will force the electromagnetic signals towards the filter apertures to interact with these.

Additionally, the filter arrangement may comprise a double aperture lower layer arranged between the bottom layer and the at least one lower layer.

In some implementations, the electromagnetic filter arrangement further comprises a top metasurface arranged on a surface of the top layer facing the at least one upper layer and a bottom metasurface arranged on a top surface of the bottom layer facing the at least one lower layer. Wherein the top and bottom metasurfaces are arranged to surround at least the filter apertures in the filter layer.

With the top and bottom metasurface the electromagnetic signals propagating along the waveguide channel and interacting with the filter apertures will be confined along the waveguide channel. This reduces signal leakage and reduces the overall losses of the filter arrangement.

In some implementations, the electromagnetic filter arrangement further comprises a first opening metasurface arranged on a surface of the top layer facing the at least one upper layer and a second port metasurface arranged on a surface of the bottom layer facing the at least one lower layer. Wherein the first port and second port metasurfaces are arranged to surround the first and second opening, respectively.

Metasurfaces arranged around the first and second opening prevent electromagnetic signals from leaking into the space between layers. By providing a metasurface surrounding each of the first and second opening this ensures that all, or more, or the signal energy is coupled into the filter arrangement and does not leak out.

In some implementations comprising both the top and bottom metasurfaces, as well as the first port and second port metasurfaces, the first port metasurface and top metasurface are separated by a flat region of the top layer surface facing the at least one upper layer and wherein the second port metasurface and bottom metasurface are separated by a flat region of the bottom layer surface facing the at least one lower layer.

That is, the each of the top and bottom layer may comprise two separate metasurfaces, one metasurface surrounding the respective opening and the other metasurface extending to surround the filter apertures when the filter apertures are projected onto the top or bottom surface. This arrangement of metasurfaces is believed to reduce losses and confine electromagnetic signals in the waveguide channel in the space surrounding the filter apertures.

In some implementations, the filter arrangement comprises at least two upper layers, each upper layer comprising a waveguide channel surrounded by a metasurface.

Additionally more than three, such as three, four, five or more upper and lower layers can be stacked on top of each other. The waveguide channel of each upper and lower layer contribute to forming a larger waveguide channel which may enhance filtering properties and reduce losses in the filter arrangement. Since each layer may be very thin, using additional upper and lower layers does not increase the total size of the filter arrangement significantly.

Optionally, the at least two upper layers comprise a first upper layer arranged closer to the top layer and a second upper layer arranged closer to the filter layer, wherein a waveguide channel of the second upper layer overlaps partially with the first opening and the waveguide channel of the first upper layer overlaps fully with the first opening or overlaps with the first opening to a greater extent than the waveguide channel of the second upper layer, when seen in a direction normal to the longitudinal plane.

This arrangement can also be repeated for an optional third or fourth upper or lower layer wherein each layer overlaps less with a projection of the first or second opening compared to a preceding layer closer to the first or second opening, when seen in a direction normal to the longitudinal plane. This arrangement forms a tapered structure which guides the electromagnetic signals to or from the filter apertures.

The arrangement of the upper layers may be mirrored in the arrangement of the lower layers. In one example, there is the same number of lower layers as there are upper layers. For example, the electromagnetic filter arrangement may comprise at least two lower layers, each lower layer comprising a waveguide channel surrounded by a metasurface.

A difference between the upper layers and the lower layers may be that none of the lower layers has a waveguiding channel which overlaps fully with the first opening while none of the upper layers has a waveguiding channel which overlaps fully with the second opening.

As an example, in one implementation the filter arrangement comprises at least three lower layers and/or at least three upper layers, each lower and upper layer comprising a waveguide channel surrounded by a metasurface.

In some implementations, the filter layer further comprises a first main aperture and a second main aperture, wherein the first set of filter apertures are arranged between the first and second main aperture, wherein the first and second main apertures are arranged to overlap with the first and second opening respectively, and wherein the first and second main apertures have a respective aperture dimension that is larger than anyone of the filter apertures.

With the main apertures being aligned with the first and second port respectively electromagnetic signals can spread to both sides of the filter layer directly upon entry into the filter arrangement. This enables the electromagnetic signals to interact with the filter layer for a large portion of the size of the filter arrangement, which in turn enables the filter arrangement to made very compact.

In some implementations, the filter layer has thickness that is smaller than a thickness of anyone of the top layer, the bottom layer, the at least one upper layer and the at least one lower layer.

The filter layer is well suited for being realized with a layer thickness which is thinner compared to other layers. For example, in some embodiments, the filter layer does not comprise any metasurface which makes this layer suitable for being realized as a thinner layer. A thin filter layer has shown to improve the filtering properties and e.g. the propagation losses for electromagnetic signals propagating along the waveguide channel. In some implementations, the thickness of the filter layer is ⅔ the thickness of any of the other layers or less, preferably ½ the thickness of any of the other layers or less and most preferably ⅓ the thickness of any other layer or less.

Each of the layers in the filter arrangement may be made of metal material or non-metal material coated with a metal on at least one side. Optionally, one or more layers is made of a non-metal material and coated with a metal on all sides.

During manufacturing, each layer may be provided as a piece of a flat sheet material whereby any waveguide channels, openings and metasurfaces are formed by etching, stamping or cutting each layer. If the flat sheet material is a non-metal material the etched, stamped or cut piece is then coated with a metal.

In some implementations, the height difference between the thick and thin sections of the metasurface is less than the wavelength at an operational frequency divided by four, preferably less than the wavelength divided by five, more preferably less than the wavelength divided by six and most preferably less than the wavelength divided by seven.

The thick sections are commonly referred to as pins and may be of any shape. Because the metasurface structures can made so shallow in comparison to the wavelength the layers themselves can be made very thin compared to the wavelength. A result of this is that the entire filter arrangement can be made very thin and compact, much thinner compared to if traditional quarter wavelength pins or half wavelength pins are used to form the metasurface.

Optionally, the thick sections have substantially the same thickness as the thickness of the corresponding layer on which they are arranged, and all thin sections are formed as recesses in the corresponding layer.

This allows the metasurface to be formed by etching from a flat sheet material piece. Additionally, it is understood that the metasurface does not necessarily cover the entire surface of a given layer but may be localized to surround only any apertures formed in the layer. The rest of each layer (that is not covered with a metasurface) may be substantially flat, such that each metasurface is surrounded by a substantially flat surface having a thickness substantially equal to the thick sections.

In some implementations, there is at least one metasurface arranged between each pair of adjacent layers in the filter arrangement. With a metasurface arranged between each pair of layers the electromagnetic signals will be confined and contained in the filter arrangement whereby losses and reflections are reduced. Arranging a metasurface between each pair of adjacent layers comprises ensuring that at least one of the layers has a metasurface facing the other layer. Optionally, each layer has a metasurface wherein the respective metasurfaces face each other. Each metasurface may comprise a plurality thick and thin sections.

In some implementations, the filter layer is free from any metasurface. This enables the filter layer to be made extra thin. Additionally, it is understood that it is still possible to arrange a metasurface between adjacent pair of layers. For example, the upper layer and lower layer being closest to the filter layer may each have a metasurface facing the filter layer.

The filter arrangement can be used to form a diplexer arrangement. Accordingly, according to some implementations there is provided a diplexer arrangement comprising the electromagnetic filter arrangement described in the above, wherein the bottom layer further comprises a third opening, the third opening being displaced from both the first and second opening in the longitudinal plane. Wherein each waveguide channel extends so as to overlap, in a direction normal to the longitudinal plane, with the first, second and third opening and wherein the filter layer comprises a second set of filter apertures. Wherein the filter apertures of the first set are arranged intermittently along the waveguide channels between the first opening and the second opening, and wherein the filter apertures of the second set are arranged intermittently along the waveguide channel between the third opening and the first opening.

Essentially, the structure of the filter layer is repeated so as to incorporate the second set of filter apertures that extend away from the overlap with the first opening to reach overlap with a third opening. By adapting each set of filter apertures after respective, different, frequency bands an electromagnetic signal injected in the first opening is divided into two signals based on frequency. The benefits and features of the filter arrangement are thus applicable also to the diplexer arrangement.

Additionally, it is noted that any features or properties discussed in relation to the top layer, double aperture upper layer and upper layer may also be present in corresponding bottom layer, double slot lower layer and lower layer, and vice versa. According to some embodiments, upper and lower layers of the filter arrangement or diplexer arrangement are symmetrical around the filter layer.

### BRIEF DESCRIPTION OF THE DRAWINGS

Aspects of the present invention will be described in more detail with reference to the appended drawings, showing currently preferred embodiments.

FIG. 1 is an exploded view of a filter arrangement according to some implementations.

FIG. 2 depicts a filter arrangement with the top and upper layers lifted to show the filter layer.

FIG. 3a depicts the bottom surface of the top layer according to some implementations.

FIG. 3b is perspective view of the top layer from FIG. 3a.

FIG. 3c depicts the bottom surface of a double aperture upper layer, suitable for arrangement as the uppermost upper layer, according to some implementations.

FIG. 3d depicts the bottom surface of an alternative upper layer.

FIG. 3e depicts the filter layer according to some implementations.

FIG. 3f depicts the top surface of a lower layer according to some implementations.

FIG. 3g depicts the top surface of a double aperture lower layer suitable for use as a lowermost lower layer.

FIG. 3h depicts the top surface of the bottom layer according to some implementations.

FIG. 3i is a cross-sectional view of the filter arrangement according to some implementations.

FIG. 4 is an exploded view of a diplexer arrangement, showing the top, upper, filter, lower and bottom layers according to some implementations.

FIG. 5a is a perspective view of the diplexer arrangement with the upper surface of the top layer visible.

FIG. 5b is a perspective view of the diplexer arrangement with the lower surface of the bottom layer visible.

FIG. 6 is a perspective view of an assembled diplexer arrangement with and epoxy glue used to seal the diplexer arrangement.

FIG. 7a depicts the bottom surface of the upper layer in the diplexer arrangement.

FIG. 7b is a perspective view of the upper layer from FIG. 7a.

FIG. 7c depicts the bottom surface of the an upper layer of the diplexer arrangement with a T-shaped channel according to some implementations.

FIG. 7d depicts the filter layer of the diplexer arrangement according to some implementations.

### DETAILED DESCRIPTION OF CURRENTLY PREFERRED EMBODIMENTS

FIG. 1 shows an exploded view of a multi-layer filter arrangement 100 according to some implementations. The filter arrangement 100 comprises a top layer 1, a bottom layer 3 and a filter layer 2 arranged between the top layer 1 and bottom layer 3. Additionally, the filter arrangement comprises a plurality of upper layers 41, 42, 43, 44 arranged between the filter layer 2 and the top layer 1 and a plurality of lower layers 51, 52, 53, 53 arranged between the filter layer 2 and the bottom layer 3.

All layers 1, 2, 3, 41-44, 51-54 are arranged in parallel on top of each other so as to form a layered structure. The layers 1, 2, 3, 41-44, 51-54 may be in physical contact with each other. However, it is noted that it is not necessary for the layers 1, 2, 3, 41-44, 51-54 to be in contact with each other and that the layers 1, 2, 3, 41-44, 51-54 may be arranged with some separation from each other.

The top layer 1 comprises an input aperture 11 and the bottom layer 3 comprises an output aperture 31. The input and output aperture 11, 31 are displaced from each other in a plane parallel to the layers. That is, there is no overlap between the input and output aperture 11, 31 when these are projected onto a plane parallel to the layers 1, 2, 3, 41-44, 51-54 (i.e. when seen in a direction normal to the longitudinal plane).

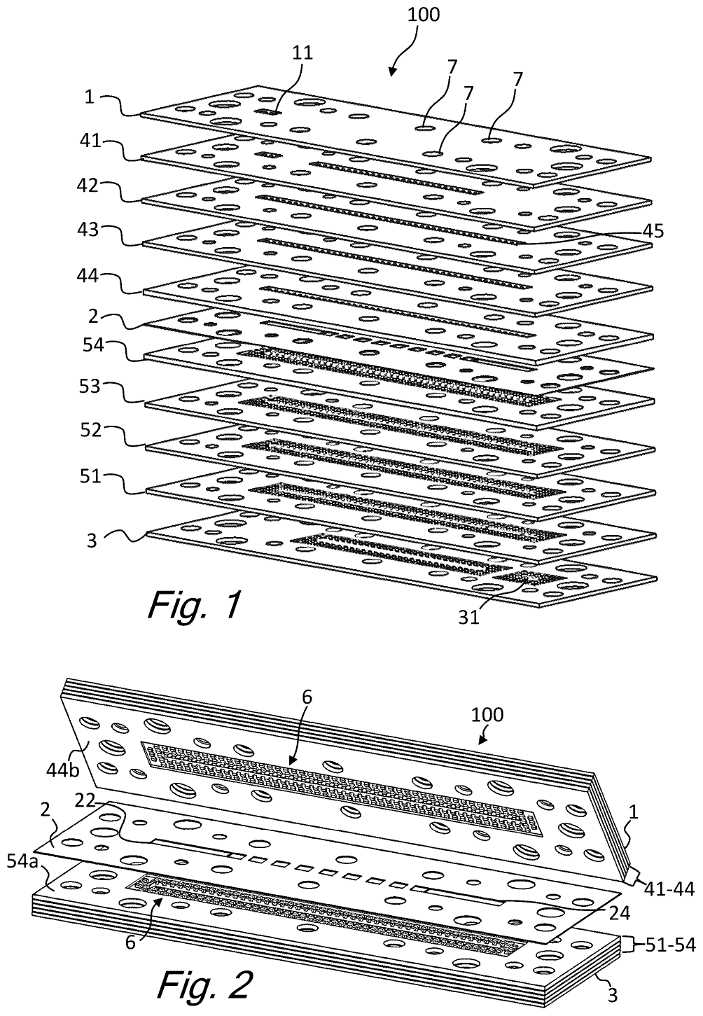

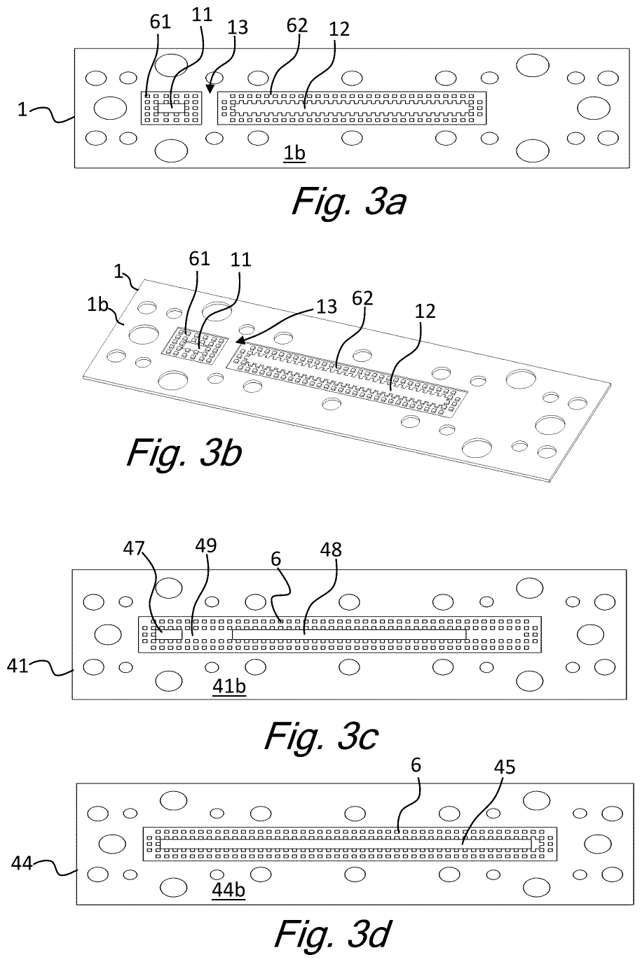

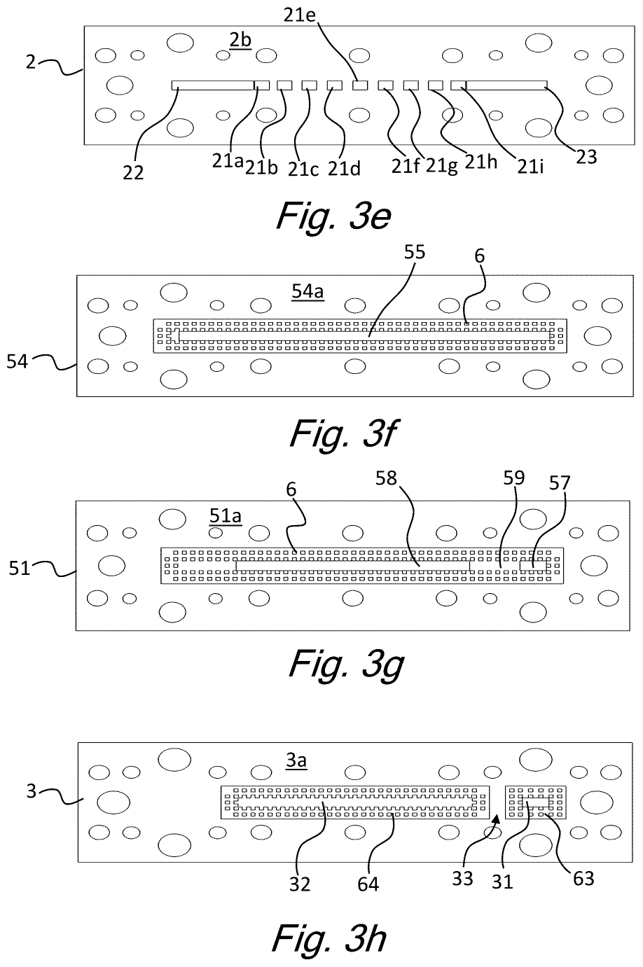

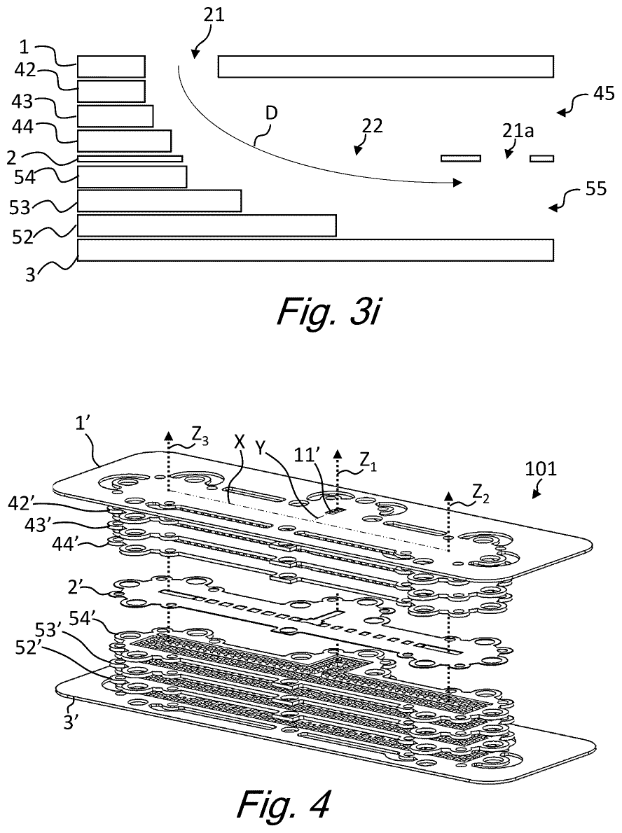

The input aperture 11 may be rectangular and e.g. configured to couple to a rectangular waveguide or active component for receiving an electromagnetic signal to be filtered. The electromagnetic signal will enter through the input aperture and propagate along a waveguide channel (see FIG. 3d) formed in the one or more upper layers 41-44 and a corresponding waveguide channel (see FIG. 3f) formed in the one or more lower layers 51-54. The filter layer 2 comprises (see FIG. 2e) a plurality of filter apertures that act as a frequency filter for the electromagnetic signals, allowing only electromagnetic signals of a passband to pass through the filter arrangement 100. The filtered electromagnetic signal will then exit the filter arrangement 100 via the output aperture 31 in the bottom layer.

To confine the electromagnetic signal along the waveguide channel and reduce any leakage between adjacent layers 1, 2, 3, 41-44, 51-54 there is a metasurface arranged in a space between each layer 1, 2, 3, 41-44, 51-54. The metasurface is a textured surface comprising thick and thin sections having a height difference that is below one quarter of the wavelength of an operational frequency, preferably less than one fifth, more preferably less than one sixth, even more preferably less than one seventh, and most preferably less than one eight of the operational frequency wavelength. In some implementations, the height difference is less than one tenth of the wavelength at the operational frequency. Additionally, the height difference (i.e. the height at which the thick sections protrude from the thin sections) may be different for metasurfaces on different layers. For example, the height difference may be larger for the thicker layers (typically the top and/or bottom layer). In some implementations, the height difference is between 0.3 mm and 0.4 mm for all layers. As another example, the height difference is between 0.4 mm and 0.5 mm for the thicker layers (typically the top and/or bottom layer) and the height difference is smaller for the remaining layers, such as between 0.3 mm and 0.4 mm. Preferably, the filter layer is without any metasurface.

Each layer 1, 2, 3, 41-44, 51-54 may be very thin, and have substantially the same thickness. For example, in some implementations each layer 1, 2, 3, 41-44, 51-54 is between 100 micrometers thick and 800 micrometers thick, preferably, between 200 micrometers and 600 micrometers, such as about 400 micrometers, and preferably combination of these.

The metasurface is according to some implementations formed by forming indentations in the layer 1, 3, 41-44, 51-54 wherein the indentations form the thin sections that outline the thick sections. That is, the thick sections may have the same thickness as the layer wherein these sections are only locally thick sections by virtue of being surrounded by thin sections.

Preferably, at least the filter layer 2 is made thinner than the other layers 1, 3, 41-44, 51-54. For example, the filter layer 2 has a filter thickness and each of the remaining layers have a respective non-filter thickness, wherein the filter thickness is smaller than any of the respective non-filter thicknesses. In one specific example, each layer 1, 3, 41-44, 51-54 except the filter layer have the same or different thickness (e.g. a thickness between 400 micrometers and 600 micrometers) wherein the filter layer 2 has a smaller thickness (e.g. 100 micrometers). Preferably, to enable the filter layer 2 to be very thin, the filter layer 2 according to some implementations does not comprise a metasurface meaning that the filter layer 2 is a flat sheet provided with a plurality of apertures. Preferably, the top and/or bottom layer 1, 3 are thicker than the upper and lower layers 41-44, 51-54, which in turn are thicker than the filter layer 2. For example, the filter layer 2 is about 100 micrometer thick, the upper and lower layers 41-44, 51-54 are about 400 micrometers thick and the top and bottom layers are about 500 micrometers thick.

Each of the layers 1, 2, 3, 41-44, 51-54 is a physical layer. For instance, at least one, or all, of the layers 1, 2, 3, 41-44, 51-54 is/are made of a respective metal material, such as brass, copper, steel, or aluminum. Additionally or alternatively, at least one of the layers 1, 2, 3, 41-44, 51-54 is made of a non-metal material (such as plastic or ceramic material) coated with a metal on at least one side. It is also envisaged that different layers are made of different materials. For example, at least one of the layers is made of a first metal material (or coated with a first metal material) whereas at least one different layer is made of a second metal material (or coated with a second metal material) that is different from the first metal material.

For example, all layers except the filter layer 2 may be made of brass and the at least one filter layer 2 is made of copper. As much of the potential losses will occur in the filter layer 2 it is preferable to use the metal material with the highest conductivity in the filter layer 2 whereas the other layers 1, 3, 41-44, 51-54 can be made of a cheaper, less conductive, metal material, such as brass or steel. In addition to brass and copper, another metal material that is suitable for making at least one of the layers 1, 2, 3, 41-44, 51-54 is aluminum.

Each layer 1, 2, 3, 41-44, 51-54 also comprises structural openings 7 arranged at corresponding locations. The structural openings 7 may be of various sizes and are used either to align the layers 1, 2, 3, 41-44, 51-54 using an alignment pin that is inserted through one or more sets of corresponding structural openings 7 or to fasten the layers 1, 2, 3, 41-44, 51-54 together using a screw or bolt that is passed though one or more corresponding sets of structural openings 7.

Various variations of the filter arrangement are considered. For example, the filter arrangement 100 may comprise five layers; the top layer 1, double aperture upper layer 41 or one of upper layers 42-44, the filter layer 2, the double aperture lower layer 51 or one of lower layers 52-54 and the bottom layer 3. The filter arrangement may also comprise seven layers; the top layer 1, the double aperture upper layer 41 and one of upper layers 42-44, the filter layer 2, the double aperture lower layer 51 and one of lower layers 52-54 and the bottom layer 3. The double aperture layers 41, 51 (if present) are located between the other upper layers and the top layer and the other layers and the bottom layer respectively. Alternatively, a seven layer filter arrangement may also be formed with; the top layer 1, two of upper layers 42-44, the filter layer 2, two of lower layers 52-54 and the bottom layer 3.

In FIG. 2 another perspective view of the filter arrangement 100 is shown with the filter layer 2, the upper layers 41-44 and the top layer 1 lifted from the lower layers 51-54 and the bottom layer 3. A lower surface 44b of the lowermost upper layer 44 facing the filter layer 2 is exposed, showing the metasurface 6 arranged to surround the waveguide channel of the upper layer 41. Similarly, an upper surface 54a of the uppermost lower layer 54 facing the filter layer 2 is exposed, showing the metasurface 6 arranged to surround the waveguide channel of the lower layer 51.

The filter layer 2 has a plurality of filter apertures including main filter apertures 22 and 23. The filter layer 2 comprises no metasurface and electromagnetic signals are confined to the wave guiding channels of the upper and lower layers 41-44, 51-54 using, in part, a metasurface 6 arranged on the top surface 54a of the uppermost lower layer 54 and a metasurface 6 arranged on the lower surface 44b of the lowermost upper layer 44. For example, it is envisaged that each of the top layer 1 and upper layers 41-44 have a metasurface 6 on a respective lower surface facing a lower adjacent layer respectively whereas each of the bottom layer 3 and lower layers 51-54 have a metasurface 6 on a respective upper surface facing an upper adjacent layer respectively. In this way, a metasurface 6 is arranged between any two neighboring layers while, at the same time, the filter layer 2 does not need any metasurface 6 and no layer has a metasurface 6 on more than one side, which facilitates manufacturing and allows the filter layer 2 to be made very thin.

However, it is understood that metasurfaces 6 may be arranged differently from the depicted example. For example, one or more of the upper or lower layers 41-44, 51-54 may have metasurface on both sides, allowing at least one adjacent upper or lower layer 41-44, 51-54 to have a no metasurface. Additionally, while at least one metasurface 6 should be preset in a space between any two adjacent layers 1, 2, 3, 41-44, 51-54 it is also possible to use two metasurfaces 6 facing each other.

With reference to FIGS. 3a-i each of the layers 1, 2, 3, 41-44, 51-54 will now be described in further detail. In FIGS. 3a and 3b the lower surface 1b of the top layer 1 is shown. The top layer 1 comprises the input aperture 11 which is surrounded with a first metasurface 61. The first metasurface 61 is formed by an indentation in the lower surface 1b surrounding the input aperture 11 wherein a plurality of thick sections (sometimes referred to as pins) are arranged in the indentation.

The lower surface 1b further comprises an elongated second metasurface 62 that is arranged separate from the input aperture 11 and first metasurface 61. The elongated second metasurface 62 is formed by an elongated indentation in the lower surface 1b wherein a plurality of thick sections are arranged in the indentation to surround an elongated surface structure 12. The elongated surface structure 12 may be provided with an elongated ridge or realized as an elongated portion of the indentation that is missing thick sections.

The first metasurface 61 is separated from the second metasurface 62 with a region 13 that that is free from any metasurface.

The lower surface 1b of the top layer 1 faces a top surface of the at least one upper layer 41, 44 shown in FIG. 3c and FIG. 3d. The top surface of the at least one upper layer 41, 44 may be substantially flat having at least one aperture 45, 47, 48 passing through to the lower surface 41b, 44b.

In some implementations, the uppermost upper layer is identical to upper layer 44 shown in FIG. 3d. In FIG. 3d the lower surface 44b of the upper layer 44 is shown. The upper layer 44 comprises an elongated waveguide channel 45 formed as an elongated aperture (slit) that extends so as to overlap with both the input aperture 11 and the elongated surface structure 12 of the top layer 1, when seen in a direction normal to the longitudinal plane. The waveguide channel is surrounded by a metasurface 6. For example, the metasurface 6 is formed as an elongated indentation surrounding the waveguide channel 45 wherein a plurality of thick sections is arranged in the indentation so as to also surround the waveguide channel 45.

Optionally, one or more additional upper layers, each similar to upper layer 44 may be arranged between upper layer 44 and the filter layer 2 wherein the waveguiding channel 45 of each upper layer will cooperate to form a waveguide channel.

In some implementations, the uppermost upper layer is different from each of the subsequent lower upper layers. For example, the uppermost upper layer may be the double aperture upper layer 41 shown in FIG. 3c with every subsequent lower upper layer being equivalent to layer 44 shown in FIG. 3d. Double aperture upper layer 41 shown in FIG. 3c comprises a single elongated metasurface 6 that delimits an elongated surface structure that extends to overlap with both the input aperture 11 of the top layer 1 and the elongated surface structure 12 of the top layer 1 when seen in a direction normal to the longitudinal plane. The elongated surface structure of the double aperture upper layer 41 comprises two apertures 47, 48 comprising a first aperture 47, overlapping at least partially with the input aperture 11 of the top layer 1, and an elongated separate second aperture 48 overlapping at least partially with the elongated surface structure of the top layer 1.

Between the first aperture 47 and the elongated second aperture 48 there is a region comprising an exposed surface 49 without metasurface that separates the first aperture 47 from the elongated second aperture 48. The second aperture 48 of the double aperture upper layer 41 is shorter compared to the waveguide channel 45 in the “single aperture” upper layer 44 (see FIG. 3d). The second aperture 48 does not overlap with either the first opening in the top layer 1 nor does it overlap with the second opening in the bottom layer 3, when seen in a direction normal to the longitudinal plane.

By using the double aperture upper layer 41 as the uppermost upper layer, instead of using upper layer 44 with a single elongated waveguide channel 45, filter performance can be increased. For example, by not having a single elongated channel 45 electromagnetic signals entering through the top layer will be forced towards the filter layer to interact with the filter layer, which prohibits electromagnetic signals from creeping along close to the top layer 1 to avoid the filter layer. The special double aperture upper layer 41 reduces locally the height of the waveguide channel so as to suppress and control spurious resonances.

The lower surface 44b of the lowermost upper layer 44 of the at least one upper layer faces the top surface of the filter layer 2. In FIG. 3e the bottom surface 2b of the filter layer 2 is shown and it is noted that both the top surface and bottom surface 2b of the filter layer may be identical.

The filter layer 2 is shown in FIG. 3e. The filter layer 2 comprises a plurality of filter apertures 21a-21i arranged so as to overlap with the waveguide channels of the upper and lower layers when seen in a direction normal to a longitudinal plane parallel with the layers. The filter apertures 21a-21i are arranged between two main apertures 22, 23. The main apertures 22, 23 comprising a first main aperture 22 overlapping (when seen in a direction normal to the longitudinal plane) with the input port in the top layer and a second main aperture overlapping with the output port of the bottom layer. The filter apertures 21a-21i may be of varying sizes and arranged at different positions depending on the desired properties (bandwidth, center frequency etc.) of the filter. For example, the filter apertures 21a-21i may be arranged with regular or irregular spacing.

For example, the filter apertures 21a-21i are all square apertures arranged symmetrically around the center filter aperture 21e, wherein the filter aperture 21a is separated from the first main aperture 22 with a distance of t₁, filter aperture 21b is separated from filter aperture 21a with a distance of t₂, filter aperture 21c is separated from filter aperture 21b with a distance of t₃, filter aperture 21d is separated from filter aperture 21c with a distance of t₄ and filter aperture 21e is separated from filter aperture 21d with a distance of t₅. The width of the filter apertures are w₁, w₂, w₃, w₄ and w₅ respectively.

In one exemplary embodiment, the arrangement of the square filter apertures 21a-21i fulfill t₁=0.15 mm, t₂=0.94 mm, t₃=1.21 mm, t₄=1.28 mm, t₅=1.3 mm with the arrangement being mirrored around the center aperture 21e. The width of the square apertures fulfills w₁=w₂=w₃=w₄=w₅=1.71 mm.

The same separation pattern is then repeated going from filter aperture 21i towards filter aperture 21e. This particular arrangement of filter apertures 21a-21i are suitable for realizing a passband between 71 and 76 GHz. However, the above measurements are merely exemplary and the person skilled in the art will realize that by adjusting the positioning, number and size of filter apertures 21a-i different filter properties can be realized.

In FIGS. 3f-3h the lower layers 51, 52 and bottom layer 3 are shown in further detail. In general, the lower layers 51, 52 and bottom layer 3 will mirror the structure of the top layer 1 and one or more upper layers 41, 44.

As shown in FIG. 3f the upper surface 54a of the uppermost lower layer 54 comprises a waveguide channel 55 that corresponds to the waveguide channel 45 from the lowermost upper layer 44. The waveguide channel 55 is surrounded with a metasurface 6. The lower layer 54 may be the only layer that is used in the filter arrangement, or it is envisaged that more than one lower layer is used. In cases where more than one layer is used, each lower layer may be similar or identical to lower layer 54 or all but the lowermost lower layer may be identical to the lower layer 54 wherein the lowermost lower layer is double aperture lower layer 51 shown in FIG. 3g.

The upper surface 51a of the double aperture lower layer 51 shown in FIG. 3g is similar to the lower surface of the double aperture upper layer shown in FIG. 3c. The lower layer 51 comprises an elongated region which is surrounded with a metasurface 6. The elongated region comprises two apertures, a first aperture 57, arranged to overlap at least partially with the output aperture 31, and a separate elongated second aperture 58, arranged to overlap at least partially with the elongated surface structure 32 of the bottom layer (see FIG. 3h), when seen in a direction normal to the longitudinal plane.

The first aperture 57 and second elongated aperture 58 are separated with a flat region 59 surrounded with the metasurface 6.

Turning to FIG. 3h, the upper surface 3a of the bottom layer 3 is shown. The bottom layer 3 is similar to the top layer 1 with the difference being that the metasurfaces 63, 64 of the bottom layer 3 are arranged on the top surface 3a as opposed to on the bottom surface as is the case for the top layer 1. The bottom layer 3 comprises an output port 31 surrounded with a metasurface 63 arranged on the upper surface 3a. A separate second metasurface 64 is also arranged on the upper surface 3a. The second metasurface 64 surrounds an elongated surface structure 32 that extends so as to overlap at least partially with the elongated waveguide channel 55 or second elongated aperture 58 of the neighboring lower layer 51, 52. In a manner analogously to the top layer, the elongated surface structure 32 of the bottom layer may be provided with a ridge or realized an elongated portion of an indentation that is missing thick sections.

FIG. 3i shows a cross-sectional view of a region in the vicinity of the first opening 11 in a filter arrangement with three upper layers 42, 43, 44 and three lower layers 52, 53, 54. Each of the upper layers 42, 43, 44 comprises a waveguide channel 45 that cooperate to form one large waveguide channel above the filter layer 2 and each of the lower layers 52, 53, 54 comprises a waveguide channel 55 that also cooperate to form a large waveguide channel below the filter layer 2. In some implementations, the waveguide channel of the upper and lower layers 42, 43, 44, 52, 53, 54 are adjusted so as to form stepwise tapered structure that guide electromagnetic signals propagating through the first opening 11 to propagate along the filter layer 2. This is illustrated schematically illustrated with arrow D indicating approximately how the electromagnetic signals are guided.

To form the stepwise tapering structure the waveguiding channel of uppermost upper layer 42 overlaps completely with the first opening 11, wherein the waveguiding channel of the subsequent upper layer 43 (that is closer to the filter layer 2) overlaps only partially with the first opening 11 and wherein the waveguide channel 45 of the further subsequent upper layer 44 (that is even closer to the filter layer 2) overlaps to a lesser extent with the first opening 11 than the upper layer 43, when seen in a direction normal to the longitudinal plane. Optionally, this pattern of less and less overlap with the first opening 11 is also continued for the lower layers 52, 53, 54 to form the stepwise tapered structure shown in FIG. 3i. Optionally, this tapered stepwise structure is present also for the second opening 31 (see FIG. 3h) and/or for each opening used in a diplexer arrangement described below, in connection to FIGS. 4-7. Additionally, a double aperture upper layer (see FIG. 3c) or double aperture lower layer (see FIG. 3g) can also cooperate with one or more upper layers 42, 43, 44 to form the stepwise tapering structure. The double aperture upper layer will be arranged between the top layer 1 and the upper layer 42. For example, the first aperture 47 of the double aperture layer overlaps fully with the first opening 11 in the top layer whereby the upper layer 42 overlaps to a lesser extent with the first opening 11 and so forth.

FIG. 4 shows an exploded view of a diplexer arrangement 101 according to some implementations. The multi-layer diplexer arrangement 101 has many features in common with the filter arrangement 100 depicted in FIG. 1. For example, both the diplexer arrangement 101 and the filter arrangement 100 comprises a top layer 1, 1′, one or more upper layers 42-44, 42′-44′, a filter layer 2, 2′, one or more lower layers 52-54, 52′-54′ and a bottom layer 3, 3′.

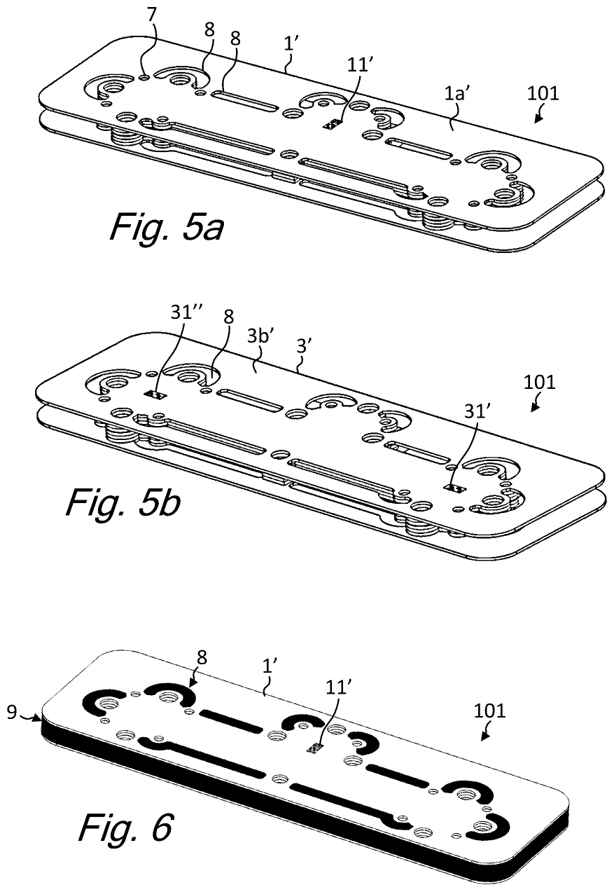

A difference between the filter arrangement 100 and the diplexer arrangement 101 is that the diplexer arrangement 101 comprises two bandpass filters and two output apertures (see FIG. 5b) while the filter arrangement comprises a single filter/output aperture and a single bandpass filter. Another difference between the filter arrangement 100 and the diplexer arrangement 101 is that the filter layer 2′ of the diplexer arrangement 101 comprises two portions, one portion that extends from the input aperture 11′ to the first output aperture and another portion that extends from the input aperture 11′ to the second output aperture wherein the two filter portions have different arrangements of filter apertures so as to filter out different frequency bands.

Optionally, the two output apertures of the diplexer arrangement 101 are arranged in the bottom layer 3′ on a same X-axis wherein the input aperture 11′ is displaced from the X-axis. In FIG. 4, the two axes Z₂ and Z₃ are perpendicular to any of the layers 1′, 2′, 3′, 41′-43′, 51′-53′ and extend through the center of each of the output apertures. The two axes Z₂ and Z₃ are therefore parallel. The axes Z₂ and Z₃ are also parallel to a Z₁-axis that extends through the center of the input aperture 11′. As seen, the X-axis extends between the Z₂ and Z₃ axes. However, the Z₁-axis is displaced from the X-axis along the Y-axis that is perpendicular to the X-axis and Z-axes.

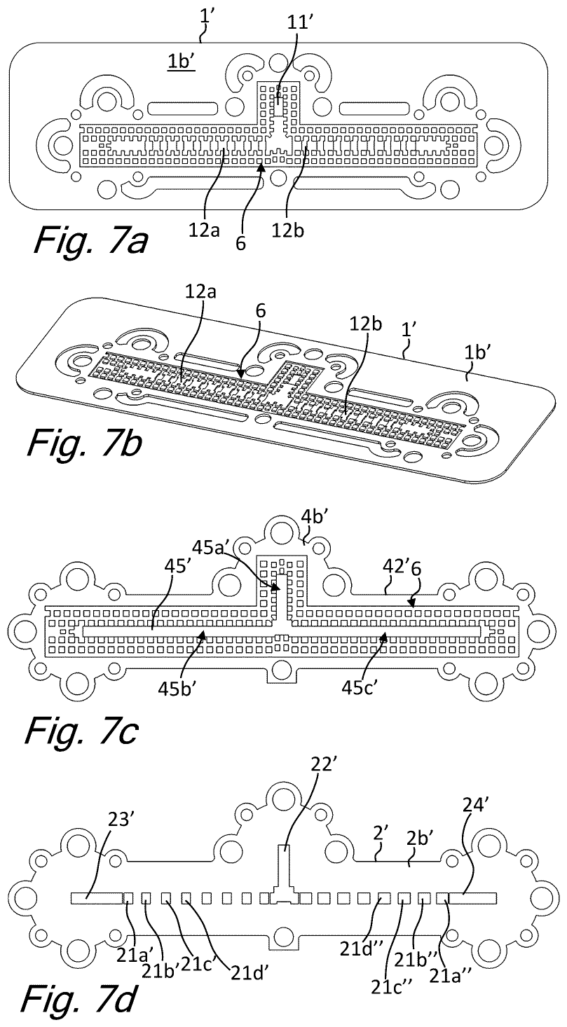

To guide electromagnetic signals from the common first opening to the two output openings, or vice versa, the waveguide channel in any of the upper layers 42′-44′ or lower layers 52′-54′ are T-shaped as seen in e.g. FIG. 7c and FIG. 7d.

In some implementations, the input aperture 11′ is displaced along the Y-axis from the position indicated in FIG. 4 such that the Z₁-axis intersects the X-axis. That is, in some embodiments, the input port 11′ and two output apertures are arranged along a straight line. While the T-shaped design offers enhanced isolation and filter properties arranging the input port 11′ and two output ports on a straight line (along the X-axis) enables the diplexer arrangement 101 to be made smaller, since the required footprint of each layer 1′, 2′, 3′, 42′-44′, 52′-54′ is reduced.

FIG. 5a shows the diplexer arrangement 101 in an assembled state with the upper surface 1a′ of the top layer 1′ visible and the input aperture 11′ is available for injecting electromagnetic signals. Similar to the filter arrangement described above, the diplexer arrangement 101 may comprise structural openings 7 used to align the layers using an alignment pin that is inserted through one or more sets of corresponding structural openings 7 and/or to fasten the layers together using a screw or bolt that is passed though one or more corresponding sets of structural openings 7. Additionally, the diplexer arrangement 101 comprises a plurality of epoxy openings 8 that are arranged in the top and/or bottom layer 1′, 3′ wherein the epoxy openings are arranged so as to follow an outer contour of the at least one upper layer 42′-44′, the filter layer 2′ and the at least one lower layer 52′-54′. That is, the footprint of the top layer 1′ and bottom layer 3′ may be larger than that of the upper, filter and lower layers 42′-44′, 2′, 52′-54′ whereby the epoxy openings are arranged in a part of the top and bottom layer 1′, 3′ that extend beyond the upper, filter and lower layers 42′-44′, 2′, 52′-54′.

With further reference to FIG. 6 it is seen that an epoxy glue 9 (epoxy resin) is injected into the space between the top layer 1′ and the bottom layer 3′ in the region where the top layer 1′ and bottom layer 3′ overhang the upper, filter and lower layers 42′-44′, 2′, 52′-54′. The epoxy glue 9 will hold mechanically the layers together and also form a watertight/airtight seal.

FIG. 5b shows the lower surface 3b′ of the bottom layer 3′ of an assembled diplexer arrangement 101. The diplexer arrangement 101 shown in FIG. 5b is the same diplexer arrangement as in FIG. 5a, wherein the diplexer arrangement 101 has been flipped to show the lower surface 3b′ of the bottom layer 3′. The bottom layer 3 has two output apertures 31′, 31″. The apertures 31′, 31″ may be referred to as a low band aperture 31′ and a high band aperture 31″. An electromagnetic signal injected into the common first opening 11′ will propagate along the channels formed in the upper and lower layers 42′-44′, 52′-54′ to reach the low band aperture 31′ and the high band aperture 31″ respectively. However, there are two sets of filter apertures arranged in the filter layer, a first set with apertures arranged along the channel going from the common first opening 11′ to the low band aperture 31′ and a second set of apertures arranged along the channel going from the common first opening 11′ to the high band aperture 31″. Each set of filter apertures are sized and arranged to filter a respective frequency band. The first set of filter apertures being configured to allow a low band of frequencies to pass and the second set of filter apertures being configured to allow a high band of frequencies to pass. Accordingly, the electromagnetic signal injected into the common first opening 11′ will be divided into to two sub-signals, a low band sub-signal exiting through the low band second opening 31′ and a high band sub-signal exiting through the high band third opening 31″.

Reversely, it is also possible to use diplexer arrangement 101 to combine two sub-signals of different frequency bands into an aggregate signal with both sub-signals superimposed. To accomplish this, one sub-signal with frequency components falling in a low frequency band is injected into the low band second opening 31′ and another sub-signal with frequency components falling in a high frequency band is injected into the high band third opening 31″ whereby the sub-signals can pass their respective set of filter apertures in the filter layer and exit the diplexer arrangement 101 via the common first opening 11′.

With reference to FIGS. 7a-d the layers 1′, 2′, 42′ of the diplexer arrangement will now be described in further detail.

The lower surface 1b′ of the top layer 1′ is shown in FIG. 7a and FIG. 7b. The common first opening 11′ is surrounded by a metasurface 6 arranged on the lower surface 1b′. The metasurface 6 is also arranged to surround a generally T-shaped region which includes the common first opening 11′ at one end of a centrally located shaft portion. The T-shaped region further comprises a beam portion with two arms that extends from the shaft portion to two respective free ends, wherein each arm extends to at least partially overlap with the low band second opening and high band third opening respectively when seen in a direction normal to the longitudinal plane.

The T-shaped region may be substantially flat portion that has is devoid of a texture metasurface. For example, the substantially flat portion has a thickness equal to that of the thin section of the metasurface 6. Optionally, one or more ridge structures are provided in the arms and/or shaft of the T-shaped region. For example, the ridge structure may be a plurality of elevated islands (see FIG. 7b) arranged at regular intervals in each of the arms, wherein the size and/or spacing of the elevated islands is different between the arms. For example, center-to-center spacing for the islands may be the same for both arms but larger islands are used for the arm overlapping the set of filter apertures that allow the low frequency components to pass and smaller islands are used for the arm overlapping the set of filter apertures that allow the high frequency components to pass. The elevation height of each island may be the same, e.g. substantially equal to the elevation of the thick sections in the metasurface 6. Any island has a total footprint area that is at least two times, preferably at least three times and most preferably at least four times the footprint area of a thick section of the metasurface.

FIG. 7c depicts the lower surface 4b′ of an upper layer 42′ of the diplexer arrangement. The upper layer 42′ comprises a channel 45′ which is generally T-shaped having a shaft portion 45a′, and a beam portion with two arms 45b′, 45c′ that extend towards respective free ends from the shaft portion 45a′. The channel 45′ is surrounded by a metasurface 6 which confines electromagnetic signals to propagate along the channel 45′.

One or more upper layers 42′ may be stacked on top of each other with overlapping channels 45′ (when seen in a direction normal to the longitudinal plane) to form a waveguide with a larger waveguiding aperture. The one or more bottom layers for the diplexer arrangement may be identical to the one or more upper layers 42′. However, preferably the metasurface of the lower layers are arranged on the upper surface instead of on the lower surface 4b′ as for the upper layers.

FIG. 7d depicts the lower surface 2b′ of the filter layer 2′ of the diplexer arrangement. As seen, the filter layer 2′ comprises two sets of filter apertures 21a′-d′, 21a″-21d″, a first set of filter apertures 21a′-d′ overlapping with a first arm of the channel in the upper/lower layer(s) (see FIG. 7c) and a second set of filter apertures 21a″-d″ overlapping the second arm of the channel in the upper/lower layer(s) when seen in a direction normal to the longitudinal plane (see FIG. 7c). In the shown example of the filter layer 2′ the filter apertures 21a′-21d′ of the first set are small and further apart compared to the filter apertures 21a″-d″ of the second set. In general, the relative sizes and spacing of the filter apertures 21a′-d′, 21a′″-d″ in the respective set depend on the low and high band frequencies of the respective bandpass filter. For example, the filter apertures 21a′-21d′ of the first set each have an aperture area that is less than 90%, preferably less than 80% and most preferably less than 70% of the aperture area for the filter apertures 21a″-d″ of the second set.

The first and second set of filter apertures, 21a′-d′, 21a″-d″ feature different size, position and/or placement of the filter apertures so as to act as frequency filters with passbands at least partially separated in frequency. For example, the first set of filter apertures 21a′-d′ having comparatively small filter apertures will allow higher frequency signals to pass whereas the second set of filter apertures 21a″-d″ having comparatively large filter apertures will allow lower frequency signals to pass. The skilled person will realize that by adjusting the size, placement or number of filter apertures the pass band of each arm of the channel can be modified accordingly.

The filter layer 2′ further comprises three main apertures 22′, 23′, 24′. The first main aperture 22′ overlaps with the shaft of the T-shaped channel and the common first opening 11′. The first main aperture 22′ allows electromagnetic signals injected into the diplexer arrangement to reach all layers prior to propagating along the channel in the upper and lower layers. Reversely, electromagnetic signals having passed the first and second set of filter apertures are concentrated by the main aperture 22′ so as to exit through the common first opening 11′. The first main aperture 22′ is elongated and extends parallel to the shaft portion of the channel in the upper and lower layer(s).

The second and third main aperture 23′, 24′ are located at the free ends of the arms of the beam portion of the channel in the upper and lower layer(s). Accordingly, the first main aperture 22′ is separated from the third main aperture 23′ with the first set of filter apertures 21a′-d′ and the first main aperture is separated from the third main aperture 24′ with the second set of filter apertures 21a″-d″.

The second main aperture 23′ forms, together with the overlapping portion of the channel in the upper/lower layers, a chamber which enables electromagnetic signals from propagating above, i.e. in the channel(s) of the upper layer(s), and below, i.e. in the channel(s) of the lower layer(s), the filter layer 2′ to be combined. The filter apertures 21a′-d′ forms a structure which acts as a filter for electromagnetic signals propagating along the elongated placement of the filter apertures 21a′-d′. A portion of the signal energy of the electromagnetic signal will be confined above the filter layer 2′ and a portion of the signal energy will be confined below the filter layer 2′. With the chamber formed in part of the second main aperture 23′ the signal energy from both sides of the filter layer 2′ will be combined prior to being ejected through the low band second opening or, reversely, the signal energy injected in the low band second opening will be allowed to enter both above and below the filter layer 2′.

Similarly, the third main aperture 24′ also forms a chamber which enables electromagnetic signals propagating out of the space above the filter layer, i.e. in the channel(s) of the upper layer(s), and the space below the filter layer, i.e. in the channel(s) of the lower layer(s), the filter layer 2′ to be combined prior to exiting through the common first opening. Reversely, the third main aperture 24′ allows electromagnetic signals injected via the high band third opening port to enter into the space above and below the filter layer.

The second and third main aperture 23′, 24′ are elongated and extend in a direction parallel to the respective arms of the beam portion of the channel, i.e. the elongated second and third main aperture are arranged perpendicular to the first main aperture 22′.

The person skilled in the art realizes that the present invention by no means is limited to the preferred embodiments described above. On the contrary, many modifications and variations are possible within the scope of the appended claims. For example, while the diplexer arrangement shown in FIG. 4, FIGS. 5a-b, FIG. 6 and FIG. 7a-d features a T-shaped channel with the low and high band openings being arranged at the free edges of the beam arms and the common first opening arranged at the free end of the shaft other designs are feasible. For example, the low band second opening, high band third opening and common first opening may be arranged in a Y-shape. Additionally, it is envisaged that more than two sets of filter apertures and associated ports can be added to form a triplexer, quadplexer or generally a multiplexer which superimposes N frequency separated signals into one common signal, or divides a common signal into N frequency separated sub-signals, wherein N is a natural number equal to or greater than two.

What is claimed is:

1. An electromagnetic filter arrangement comprising a plurality of stacked layers, the stacked layers comprising:
a top layer,
a bottom layer,
a filter layer arranged between the top layer and bottom layer,
at least one upper layer arranged between the top layer and the filter layer,
at least one lower layer arranged between the bottom layer and the filter layer,
wherein the top layer comprises a first opening and the bottom layer comprises a second opening, the second opening being displaced from the first opening, when seen in a direction normal to a longitudinal plane, the longitudinal plane being parallel to the stacked layers,
wherein at least one of said at least one upper layer and at least one of said at least one lower layer comprises an elongated aperture forming a waveguide channel, each waveguide channel extending so as to overlap, when seen in a direction normal the longitudinal plane, with the first and second opening, respectively,
wherein the filter layer comprises a first set of filter apertures, the filter apertures of the first set being arranged along the waveguide channels of the at least one upper layer and the at least one lower layer, and
wherein a metasurface is arranged between the at least one upper layer and the filter layer and between the at least one lower layer and the filter layer, respectively, wherein the metasurfaces surrounds the waveguide channels and wherein the metasurfaces comprise a plurality of thick and thin sections.

2. The electromagnetic filter arrangement according to claim 1, further comprising a double aperture upper layer, the double aperture upper layer being arranged between the top layer and the at least one upper layer, wherein the double aperture upper layer comprises two separate apertures arranged along the waveguide channel, one aperture overlapping with the first opening and the other aperture extending along the waveguide channel, when seen in a direction normal to the longitudinal plane, wherein the separate apertures of the double aperture upper layer are surrounded by a metasurface.

3. The electromagnetic filter arrangement according to claim 2, wherein the metasurface surrounding the apertures of the double aperture upper layer is arranged on a bottom surface of the double aperture upper layer facing the at least one upper layer, wherein the metasurface of the double aperture upper layer surrounds a common area, and wherein said two separate apertures of the double aperture upper layer are arranged inside the common area.

4. The electromagnetic filter arrangement according to claim 1, further comprising a top metasurface arranged on a surface of the top layer facing the at least one upper layer and a bottom metasurface arranged on a top surface of the bottom layer facing the at least one lower layer,
wherein the top and bottom metasurfaces are arranged to surround at least the filter apertures in the filter layer, when seen in a direction normal to the longitudinal plane.

5. The electromagnetic filter arrangement according to claim 1, further comprising a first opening metasurface arranged on a surface of the top layer facing the at least one upper layer and a second opening metasurface arranged on a surface of the bottom layer facing the at least one lower layer, wherein the first opening and second opening metasurfaces are arranged to surround the first and second opening, respectively.

6. The electromagnetic filter arrangement according to claim 5, when depending on claim 4, wherein the first opening metasurface and top metasurface are separated by a flat region of the top layer surface facing the at least one upper layer and wherein the second opening metasurface and bottom metasurface are separated by a flat region of the bottom layer surface facing the at least one lower layer.

7. The electromagnetic filter arrangement according to claim 1, comprising at least two upper layers, each upper layer comprising a waveguide channel surrounded by a metasurface.

8. The electromagnetic filter arrangement according to claim 7, wherein the at least two upper layers comprise a first upper layer arranged closer to the top layer and a second upper layer arranged closer to the filter layer, wherein a waveguide channel of the second upper layer overlaps partially with the first opening, when seen in a direction normal to the longitudinal plane, and the waveguide channel of the first upper layer overlaps fully with the first opening or overlaps with the first opening, when seen in a direction normal to the longitudinal plane, to a greater extent than the waveguide channel of the second upper layer.

9. The electromagnetic filter arrangement according to claim 1, comprising at least two lower layers, each lower layer comprising a waveguide channel surrounded by a metasurface.

10. The electromagnetic filter arrangement according to claim 1, comprising at least three lower layers and/or at least three upper layers, each lower and upper layer comprising a waveguide channel surrounded by a metasurface.

11. The electromagnetic filter arrangement according to claim 1, wherein the filter layer further comprises a first main aperture and a second main aperture, wherein the first set of filter apertures are arranged between the first and second main aperture, wherein the first and second main apertures are arranged to overlap with the first and second opening respectively, when seen in a direction normal to the longitudinal plane, and wherein the first and second main apertures have a respective aperture dimension that is larger than anyone of the filter apertures.

12. The electromagnetic filter arrangement according to claim 1, wherein the filter layer has thickness that is smaller than a thickness of anyone of the top layer, the bottom layer, the at least one upper layer and the at least one lower layer.

13. The electromagnetic filter arrangement according to claim 1, wherein each of the layers is made of metal material or non-metal material coated with a metal.

14. The electromagnetic filter arrangement according to claim 1, wherein the height difference between the thick and thin sections of all metasurfaces is less than the wavelength at an operational frequency divided by four, preferably less than the wavelength divided by five, more preferably less than the wavelength divided by six and most preferably less than the wavelength divided by ten.

15. The electromagnetic filter arrangement according to claim 1, wherein all the thick sections have substantially the same thickness as the thickness of the corresponding layer on which they are arranged, and all thin sections are formed as recesses in the corresponding layer.

16. The electromagnetic filter arrangement according to claim 1, wherein each metasurface is surrounded by a substantially flat surface having a thickness substantially equal to the thick sections.

17. The electromagnetic filter arrangement according to claim 1, wherein at least one metasurface is arranged between each pair of adjacent layers.

18. The electromagnetic filter arrangement according to claim 1, wherein the filter layer is free from any metasurface.

19. A diplexer comprising the electromagnetic filter arrangement according to claim 1,
wherein the bottom layer further comprises a third opening, the first opening on the top layer being displaced from both the second and third opening in the longitudinal plane,
wherein each waveguide channel extends so as to overlap, when seen in a direction normal to the longitudinal plane, with the first, second and third openings,
wherein the filter layer comprises a second set of filter apertures,
wherein the filter apertures of the first set are arranged intermittently along the waveguide channels between the first opening and the second opening, and
wherein the filter apertures of the second set are arranged intermittently along the waveguide channel between the third opening and the first opening.
